(19) United States
(12) Patent Application Publication
(10) Pub. No.: US 2024/0181329 A1
(43) Pub. Date: Jun. 6, 2024

(54) TOY FOR A GAME AND PROGRAM THEREFOR

(71) Applicant: BANDAI CO., LTD., Tokyo (JP)

(72) Inventor: Tomonori FUKUI, Tokyo (JP)

(21) Appl. No.: 18/527,717

(22) Filed: Dec. 4, 2023

(30) Foreign Application Priority Data
Dec. 5, 2022 (JP) 2022-194551

(51) Int. Cl. A63F 1/02; A63F 1/06

(52) U.S. Cl. CPC A63F 1/02; A63F 1/067; A63F 2011/0086; A63F 2300/10

(57) ABSTRACT

A game toy comprises first type game items each of which is associated with a character, and a play sheet in which some of the first type game items are placed. The first type game items include first information indicating a first condition for placing the first type game items on the play sheet, and second information, which is an element of the first condition of the first information of another first type game item. The play sheet includes a first placement area where the first type game items can be placed, and a second information used to determine whether the first condition of the first information of the first type game item is met is the second information of the first type game item placed in the first placement area.

### CROSS-REFERENCE TO RELATED APPLICATIONS

The disclosure of Japanese Patent Application No. 2022-194551 filed on Dec. 5, 2022 including specification, drawings and claims is incorporated herein by reference in its entirety.

### TECHNICAL FIELD

The present invention relates to a toy for a game and a program therefor.

### BACKGROUND

Battle type card games are popular with not only lovers of such games but also game card collectors since a character drawn on each of cards is popular (For example, Patent Document 1) in addition to amusingness of the games.

### PRIOR ART

### Patent Documents

[Patent Document 1] Japanese Patent No. 4786204

### SUMMARY

### Technical Problem

It is desired to realize a toy for a game and a program therefor, which enhance enjoyability of a card game without attractiveness of such cards themselves. Here, it is an object of the present invention to provide a toy for a game and a program therefor, which enhance enjoyability of such a card game.

### Solution to Problem

One of the aspects of the present invention is a toy for a game. The toy for a game includes first type game items which are respectively associated with characters, and a play sheet on which some of the first type game items are placed. Each of the first type game item indicates first information indicating a first condition for arranging a first type game item(s) on the play sheet, and second information, which is an element of the first condition included in the first information for another first type game item. The play sheet has a first placement area within which the first type game item(s) can be placed. The second information, which is used to make a determination on whether the first condition indicated in the first information of the first type game item is satisfied, is the second information of the first type game item placed on the first placement area.

Another aspect of the present invention is a program. The program causes a computer to function as a display unit which displays a play sheet on which some of the first kind game items respectively associated with characters are arranged, and a control unit which controls a game. Each of the first kind game items includes first information indicating a first condition for placing the first type game item on the play sheet, and second information, which is an element of the first condition indicated in the first information of another first kind game item. The play sheet includes a first placement area in which some of the first kind game items can be placed. The control unit determines whether or not the first condition indicated in the first information of a first type game item is satisfied, by using the second information of the first type game item placed on the first placement area.

### Advantageous Effect of Invention

According to the present invention, it is possible to provide a toy for a game which enhances enjoyability.

### ADVANTAGEOUS EFFECT OF INVENTION

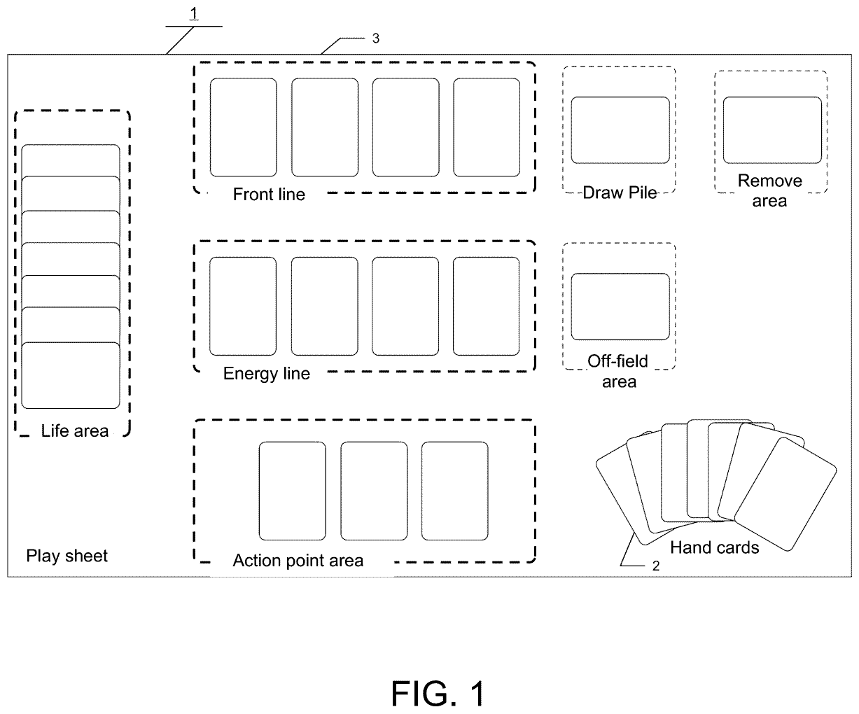

FIG. 1 is a schematic view of a toy for a game according to an embodiment;

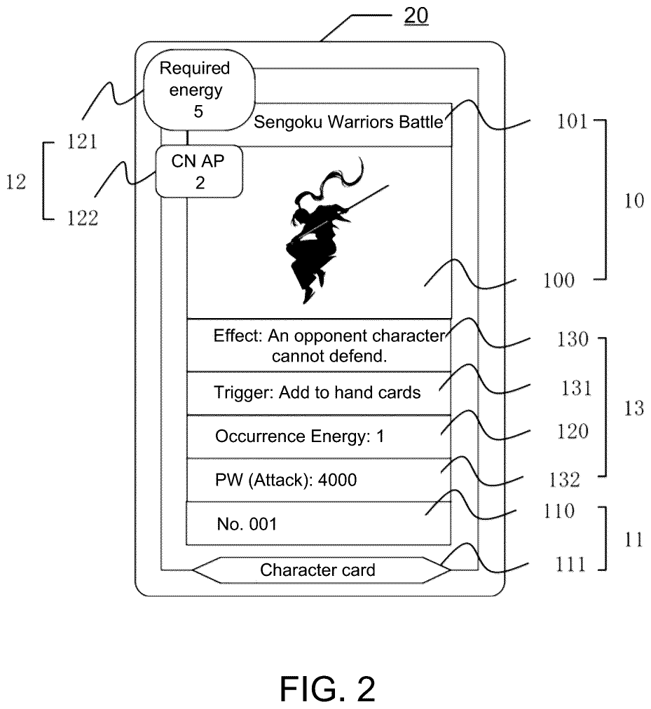

FIG. 2 shows an example of a front face of a character card 20;

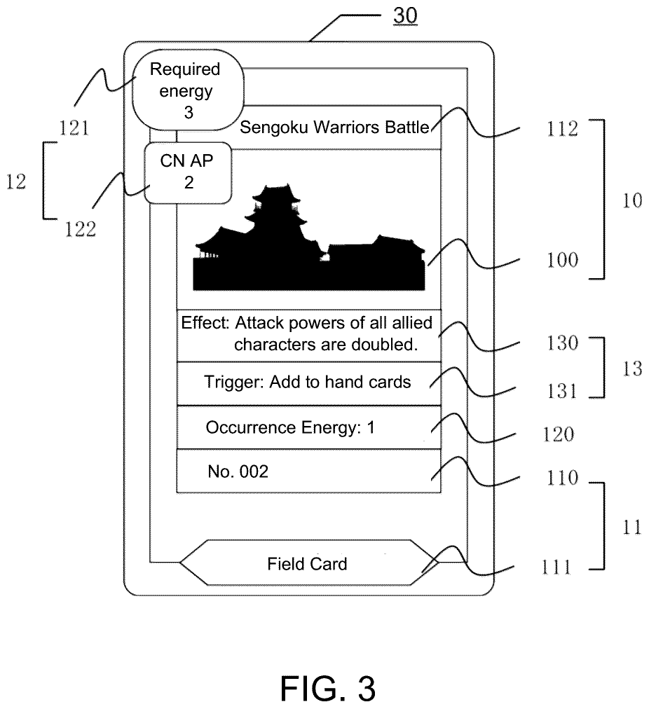

FIG. 3 is a diagram showing an example of a front face of a field card 30;

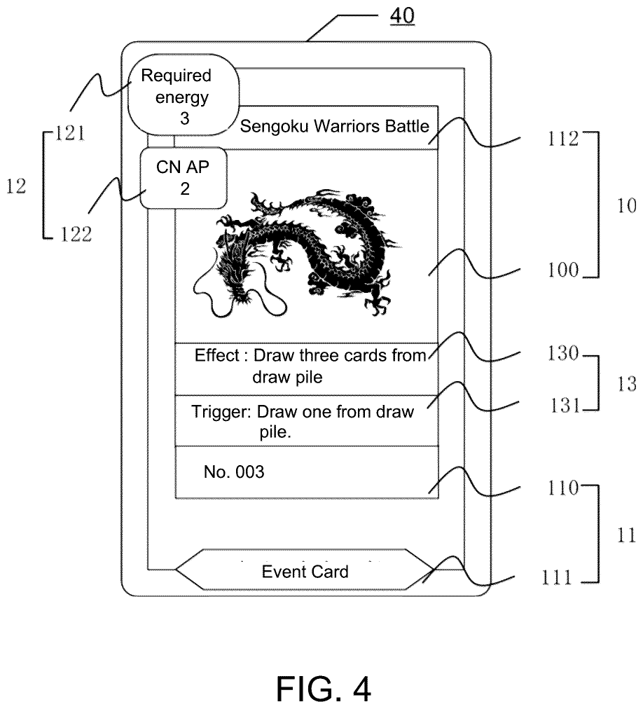

FIG. 4 is a diagram showing an example of a front face of an event card 40;

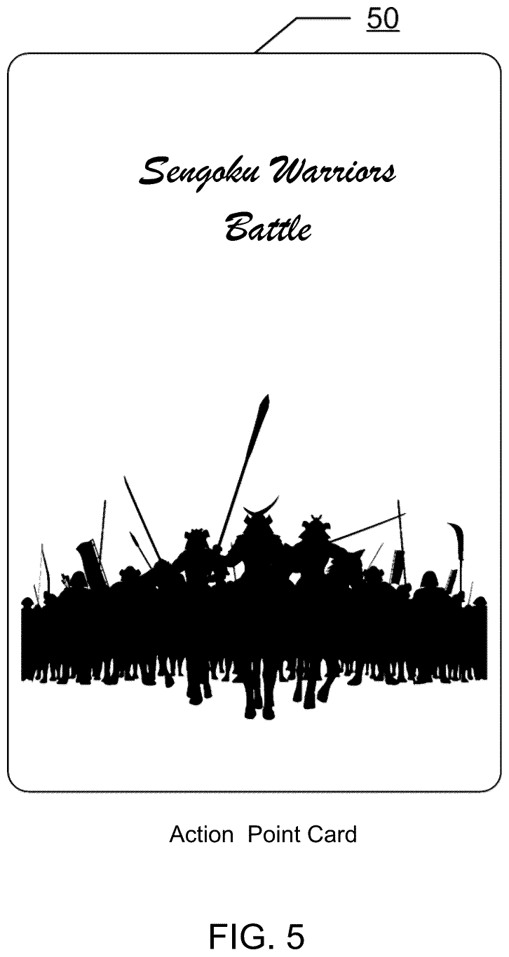

FIG. 5 is a diagram showing an example of a front face of an action point card 50;

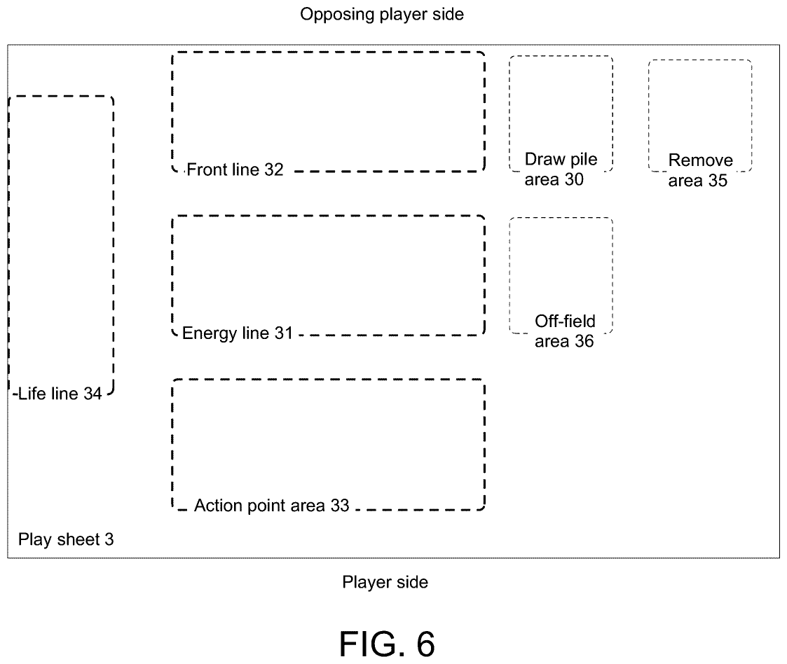

FIG. 6 is a diagram showing an example of a play sheet 3;

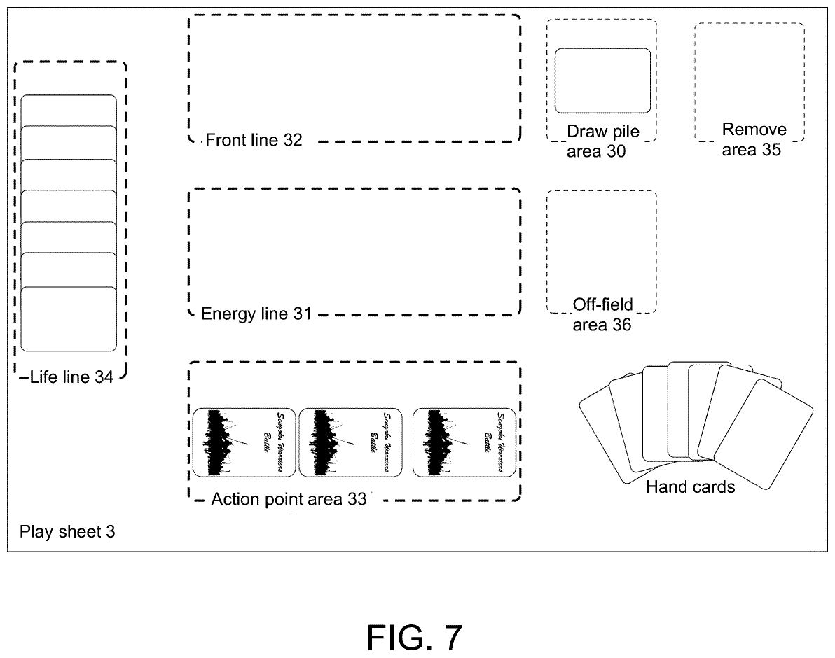

FIG. 7 is an example of a toy for a game 1 at time when preparation of a game is competed;

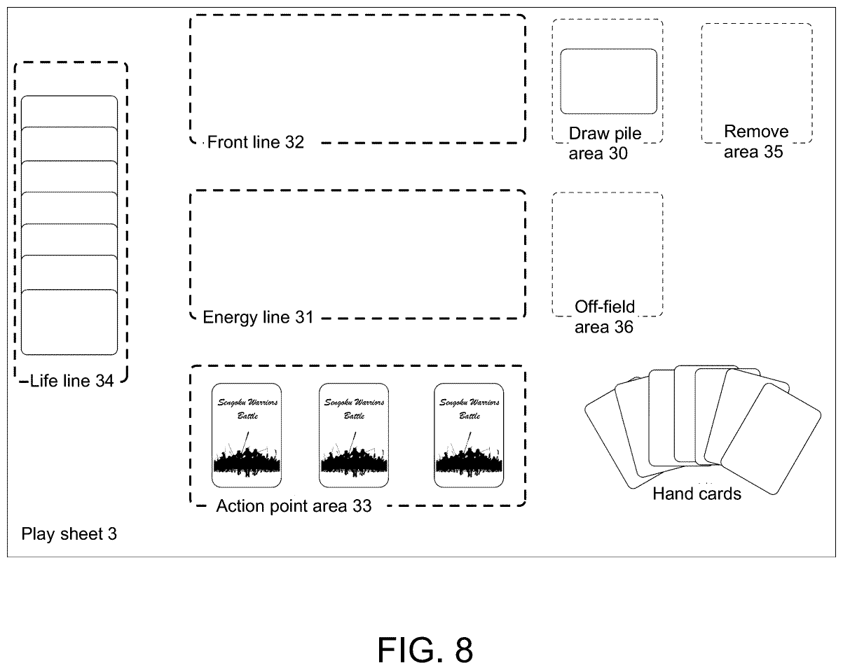

FIG. 8 is an example illustrating a state of a start phase;

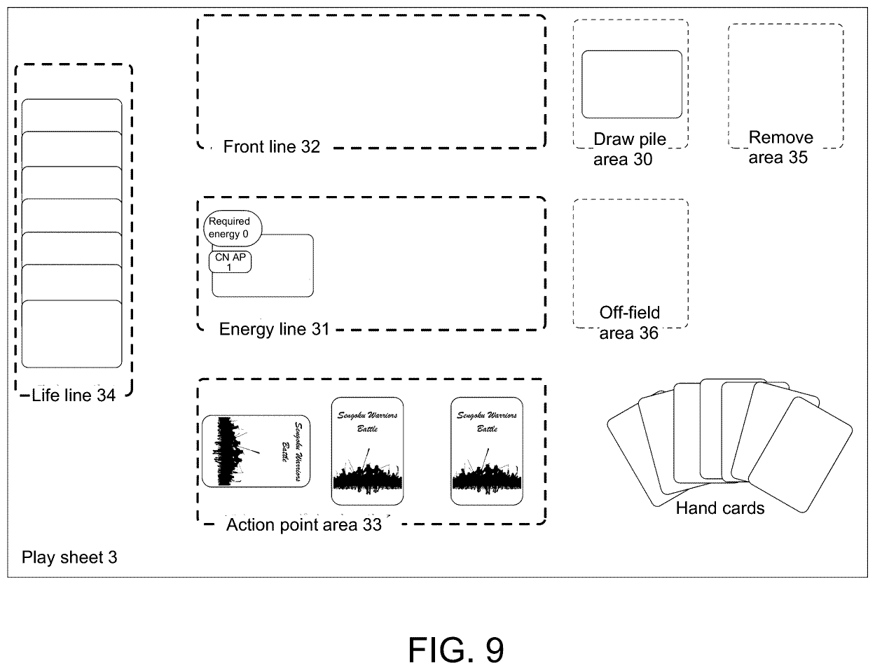

FIG. 9 shows an example of a state of a main phase;

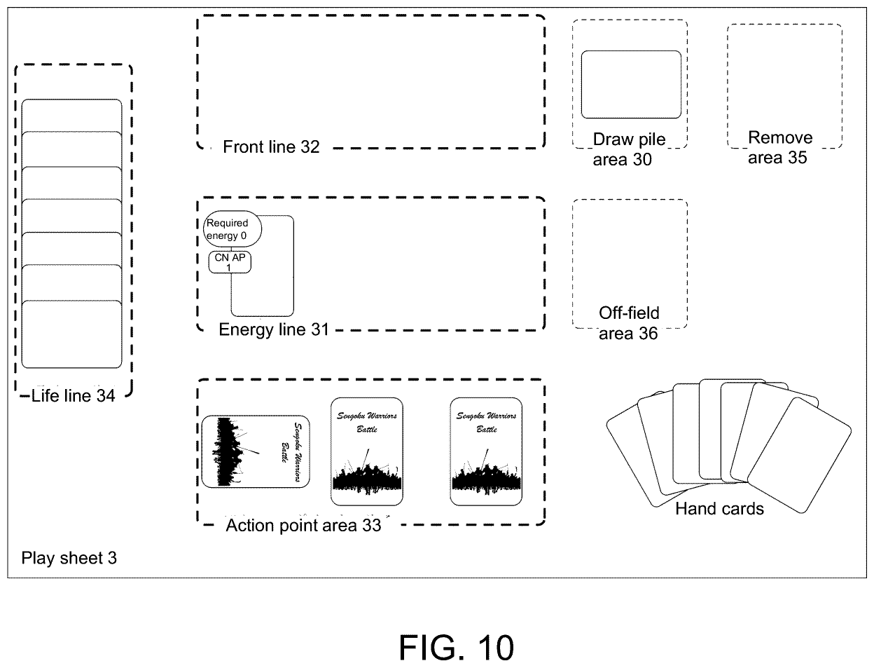

FIG. 10 shows an example of a state of a main phase;

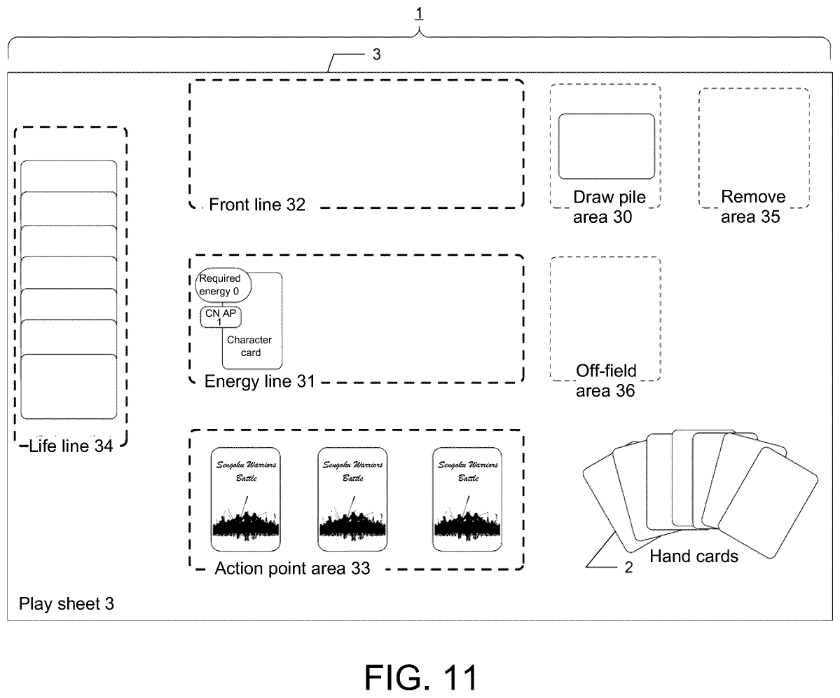

FIG. 11 shows an example of a state of an end phase;

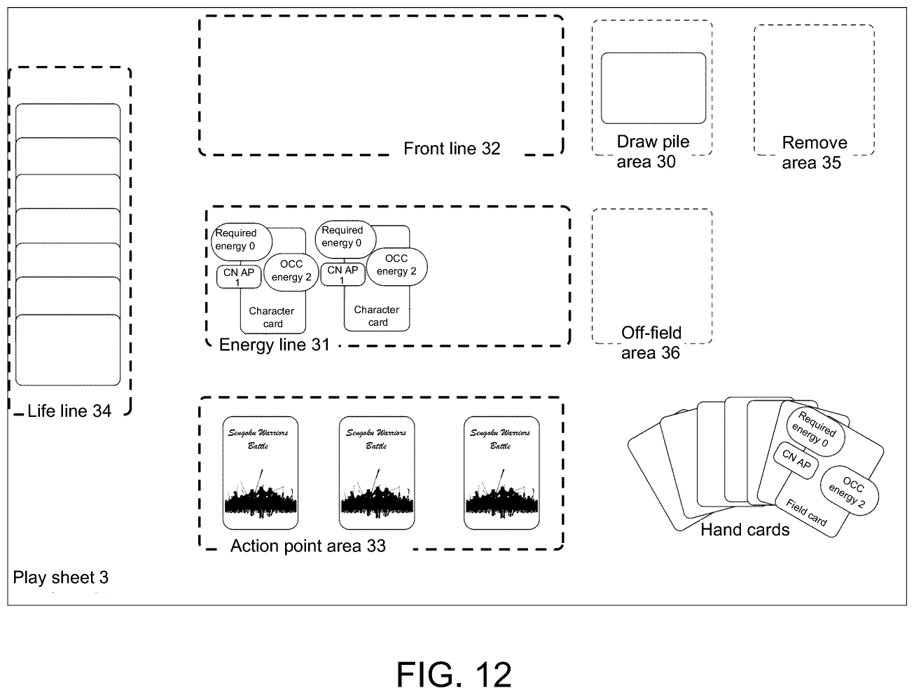

FIG. 12 shows an example of a state of a start phase;

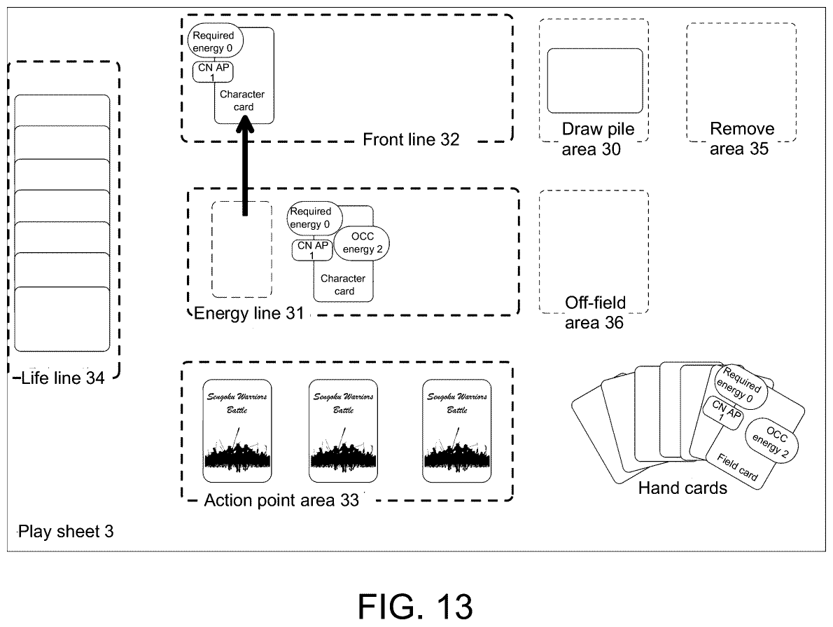

FIG. 13 shows an example of a state of a transfer phase;

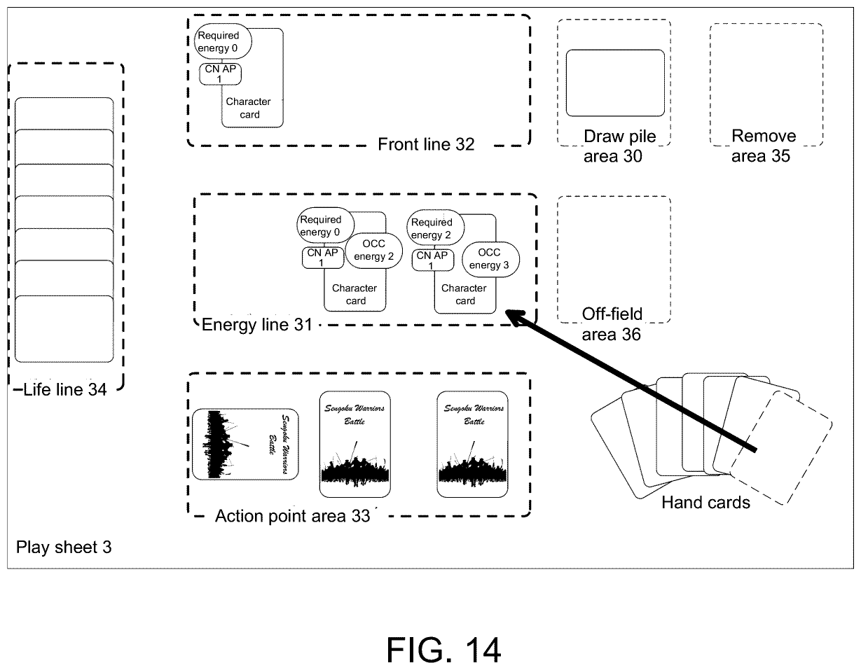

FIG. 14 shows an example of a state of a main phase;

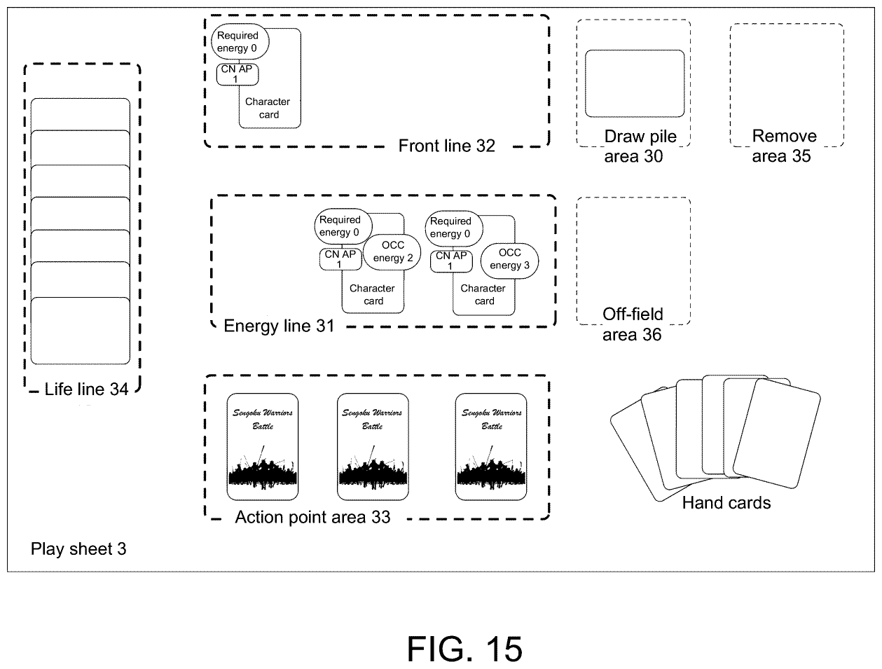

FIG. 15 shows an example of a state of a main phase;

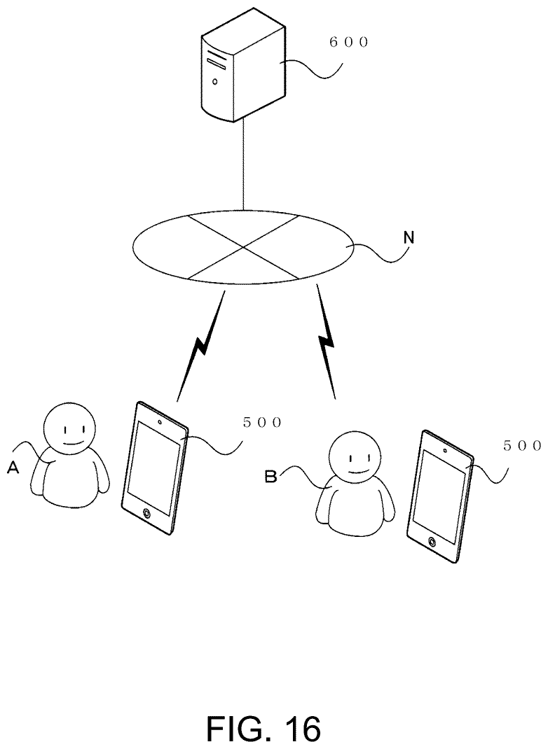

FIG. 16 shows an overall configuration example illustrating a game system according to a second embodiment; and

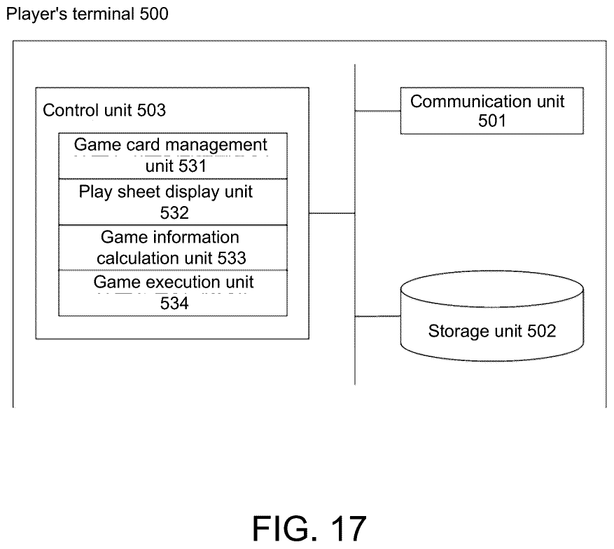

FIG. 17 is a block diagram of a player terminal 500.

### DETAILED DESCRIPTION

A first embodiment of the present invention will be described below. The present invention relates a toy for a game, which is a battle type game where a match game is played with an opponent by placing game items on a play sheet. Each of game items is associated with a character, and a plurality of regions (areas) where game items are placed are allocated on the play sheet. A player places the game items on the regions (areas) and plays the game using ability of a character associated with each of the game items.

### First Embodiment

FIG. 1 is a schematic view for illustrating a game toy according to the present embodiment. As shown in FIG. 1, the game toy 1 includes game cards 2 and a play sheet 3.

The game cards 2 correspond to the above-mentioned game items, held by the player. The player can buy such cards. Cards can be exchanged between players. Or a player, who has satisfied a predetermined condition, can acquires a game card(s) 2 by distribution etc.

The game cards 2 according to the present embodiment, can be grouped according to works having the same world view (series) in animations, movies, cartoons, games and the like. The player forms a deck from the game cards belonging to one group (work) at time of deck formation. Further, when the player plays a battle with an opponent, the players may use game cards belonging to the same work or different work.

Each of the game cards 2 has a front face and a back face. In the present embodiment, two or more kinds of card game sets are prepared. Information shown on a front face of the game card is different from one another, depending on the kinds of sets of the game cards 2. The number of kinds of game cards 2 is not limited to a fixed number. Description thereof will be given below, using the four kinds of game cards such as character cards 20, field cards 30, event cards 40 and action point (AP) cards 50.

As mentioned above, the four kinds of sets of game cards 2 are used. The common feature among all the kinds of cards is that they include at least either a character image (illustration) capable of identifying the work to which the card belongs, or a description (such as the title of the work). Furthermore, the game cards 2 also share a common feature in which the game cards 2 are respectively associated with images or information relating to the characters of the work to which the game cards 2 belong. Players who are familiar with the work can form a deck made up of game cards of the same work by intuitively referring to the character images or the character-related information, while players who are unfamiliar with the work can form such a deck made up of the game cards belonging to the same work by referring to the descriptions. The characters are ones that appear in such work. Information about the character includes distinctive scenes, settings, landscapes, backgrounds, buildings, character belongings, events etc. that appear in the work.

Furthermore, the game card 2 has a normal position, where the content written on the game card 2 can be directly discerned when viewed by the player. There are two or more placement states of the game card 2. In the description set forth below, a state where the game card 2 is in the normal position is referred to as an active state, and a state where the game card 2 is rotated sideways by 90 degrees is referred to as a rest state. A specific orientation is predefined as the active state, and an orientation of the game card, which is changed from the predefined orientation, may be regards as the rest state.

### <Character Card>

FIG. 2 illustrates an example of a front face of a character card 20. The character cards 20 are fundamental cards for the game, serving as game cards by which a battle is performed with such character cards 20 of an opponent. The character card(s) 20 can be placed on a front line and an energy line of the play sheet 3, as described later. The character card(s) 20 placed on the energy line is drawn from the player's hand. The character card(s) 20 placed on the front line can be moved from either the player's hand or the energy line. The character card(s) 20 placed on the front line can either attack an opponent's character card(s) or be attacked by an opponent's character card(s). Each of the character cards 20 contains character information 10, card information 11, energy information 12, and ability information 13.

The character information 10 includes at least image information 100 and a work title 101. The image information 100 includes an illustration of a character which appears in the work or character-related information, wherein at least part of ability information of the character card can be intuitively known from the illustration. Moreover, there may be two or more game cards 2 associated with the same character, but the illustrations thereof are different from each other, and each of the game cards is treated as a distinct game card 2. The work title 101 contains the title of the work to which the game card belongs. In the example shown in FIG. 2, “Sengoku Warriors Battle”′ is shown as the work title 101. As mentioned above, each of the players builds his or her own deck by referring to the work title 101 and using game cards with the same work title.

The card information 11 includes at least a card number 110 and a card type 111 as information for individually distinguishing the card from other cards. The card number 110 contains identification information for uniquely identifying the game card 2. In the example shown in FIG. 2, “001” is shown as the card number 110. The card type 111 shows information indicating one of a character card, a field card, an event card, and an action point. In the example in FIG. 2, “Character card” is written as the card type 111.

Furthermore, the card information 11 may also include a card name which allows intuitive recognition of the character card 20 itself or the ability information of the character card 20, and color information to which the game cards grouped into multiple colors belong, rarity information assigned according to the number of game cards issued, and similar details.

The energy information 12 contains information used to determine whether the player meets the conditions for placing game card(s) from his or her hand onto the play sheet 3. The energy information 12 includes at least occurrence energy information 120 (corresponding to the second information), required energy information 121 (corresponding to the first information), and consumption action point information 122 (corresponding to the third information).

The occurrence energy information 120 contains a numerical value representing occurrence energy, which is an element of the conditions for placing game card(s) from the player's hand onto the play sheet 3 when the game card(s) has been already placed on the play sheet 3. In the example shown in FIG. 2, “1” is written as the occurrence energy information.

In the required energy information 121, a numerical value of the required energy, which is a condition for placing a game card(s) 2 (a condition under which the game card(s) can be placed) from the player's hand onto the play sheet 3, is contained. In the example in FIG. 2, the required energy information is shown as “5.” For instance, if there are five game cards, on which “1” is written as the occurrence energy information 120, in the energy line of the play sheet 3, the total occurrence energy is “5.” Therefore, the player can place a game card, on which “5 or lower” is written in the required energy information 121, from his or her hand on the play sheet 3.

The number of the action point cards 50 to be consumed when the player places a character card 20 on the play sheet 3 from his or her hand, is specified in the consumption action point information 122. In the example in FIG. 2, the consumption action point information is shown as “2,” indicating that two action point cards 50 are consumed to place a character card 20 from his or her hand.

The ability information 13 includes at least effect information 130, trigger information 131, and power information 132, which is referred to during a game battle. The ability information 13 may be included in the character information 10, but in the description of an example set forth below, the ability information is not included in the character information.

In case where a card is placed on the play sheet 1, an effect which can be obtained by the game card 2 placed on play sheet 3 is specified in the effect information 130. In the example in FIG. 2, it states “An opponent character cannot defend.”

An action, which is executed when the player is attacked by the opponent in a state where a character card 20 is placed on the play sheet 3 from his or her hand, is specified in the trigger information 131. In the example in FIG. 2, “Add to hand” is shown as a trigger action.

In the power information 132, either an attack value or a defense value is written. When the attack value specified in the power information 132 is greater than the defense value of the opponent's character card 20, the character card 20 with the specified attack value will win. In the example in FIG. 2, “Attack value 4000” is shown as the power information 132.

### <Field Card>

FIG. 3 is a diagram illustrating an example of a front face of a field card 30. The field card 30 supports the character card 20. The field card(s) 30 can be placed on the energy line of the play sheet 3, which is described later. The field card(s) 30 is placed on the energy line from the player's hand. The field card 30 includes the character information 10, the card information 11, the energy information 12, and the ability information 13, similarly to the character card 20.

The character information 10 includes illustration information 100 and a work title 112. The illustration information 100 includes a character illustration or information relating to a character which appears in the work to which the field card 30 belongs. The illustration information 100 on the field card 30 may be unrelated to the ability information of the card, but it is preferable that at least part of the ability information of the field card 30 can be intuitively apparent from the illustration. Furthermore, it is most preferable that the illustration relates to the content of the work to which the field card 30 belongs, and at least part of the ability information of the field card 30 can be intuitively apparent. This ensures that even if players do not memorize the ability information of each card, some of the ability information can be intuitively understood, thereby preventing game progress from delaying due to understanding of the card ability, and thereby preserving the overall enjoyment of the game.”

Similar to the above-mentioned character card 20, in the work title 112, the title of the work to which the game card belongs is written. In the example shown in FIG. 3, “Sengoku Warlords Battle” is shown as the work title 101.

Similar to the above-mentioned character card 20, the card information 11 includes at least the card number 110 and the card type 111. In the example shown in FIG. 3, “002” is shown as the card number 110, and “Field Card” is shown as the card type 111.”

Similar to the above-mentioned character card 20, the energy information 12 includes occurrence energy information 120, required energy information 121, and consumption action point information 122. In the example shown in FIG. 3, “1” is recorded as the occurrence energy information, “3” as the required energy information, and “2” as the consumption action point information.

Similar to the above-mentioned character card 20, the ability information 13 includes effect information 130 and trigger information 131. The difference between this and the character card 20 is that the ability information 13 does not include the power information 132. In other words, the field card 30 cannot be placed on the front line of the play sheet 3 unlike the character card(s) 20, and cannot attack the character card 20 of the opponent. In the example in FIG. 3, the effect information 130 shows “Attack powers of all allied characters are doubled,” and the trigger information 131 shows “Add to hand cards.”

### <Event Card>

FIG. 4 is a diagram illustrating an example of the front face of an event card 40. The event card 40 is not placed in any one of the areas of the play sheet 3, as described later, but allows the player to execute the content written in the ability information of the event card 40 by placing the card from the hand on the play sheet 3 (brought into the field). Each of the event cards 40 includes character information 10, card information 11, energy information 12, and ability information 13, like the character cards 20 and the field cards 30.

The character information 10 includes the illustration information 100 and the work title 112. The illustration information is an illustration relating to a character or information about the character which appears in the work to which the event card 40 belongs. The illustration depicted on the event card 40 may be related to the ability information of the event card 40, but it is preferable to feature a distinctive scene, settings, landscape, background, buildings, character possession, or an event which represents the work to which the event card 40 belongs.

Similar to the character cards 20 and the field cards 30, the card information 11 includes at least the card number 110 and the card type 111. In the example in FIG. 4, “003” is shown as the card number 110, “Event Card” as the card type 111, and “Sengoku Warlords Battle” as the work title 112.

Similar to the character cards 20 and the field cards 30, the energy information 12 includes required energy information 121 and consumption action point information 122. Since the event card 40 is not placed in any of the areas of the play sheet 3, the occurrence energy information 120 is not included therein unlike the character cards 20 and the field cards 30. In the example shown in FIG. 4, “3” is shown as the required energy information, and “2” as the consumption action point information.

Similar to the field cards 30, the ability information 13 includes the effect information 130 and the trigger information 131. In the example shown in FIG. 4, “Draw three cards from draw pile” is shown in the effect information 130, and “Draw I card from the deck” is shown in the trigger information 131.

### <Action Point Card>

FIG. 5 is a diagram illustrating an example of the front face of an action point card 50. The action point card 50 is a game card to be placed in the action point area of the play sheet 3, as described later. Unlike the character cards 20, the field card 30s, and the event cards 40, the action point card 50 is not placed on the play sheet 3 from the player's hand, but the predetermined number of the action point cards 50 are placed in the action point card area from the beginning of the battle game. The action point cards 50 are placed in an active state in an initial stage of the action point cards 50 placed at the beginning of the battle. The action point cards 50 are consumed by the number thereof shown in the consumption action point information 122 of the character card 20, the field card 30, and/or the event card 40 when the player places the character card 20, the field card 30, and/the event card 40 from his or her hand on the play sheet 3. In other words, the player expends the action point cards to place either any of the character card(s) 20, the field card(s) 30, or the event card(s) 40 from his or her hand. At this time, the player changes the state of the action point cards from the hand, whose number is equal to the numeric value indicated by the consumption action point information, from an active state to a rested state, in order to show that they have been consumed.”

Each of the action point cards 50 has character information 10 which includes the illustration information 100 and the work title 101, similarly to the character cards 20, the field cards 30, and the event cards 40. However, unlike the character cards 20, the field cards 30, and the event cards 40, there is no need to include the card information 11, the energy information 12, and ability information 13, which is information relating to the game's battle, on the action point cards 50. Therefore, the action point cards having high designability and collectible quality are preferred. Since the action point cards 50 are constantly placed on the play sheet 3 during the game battle and are always visible to the battle players, players' satisfaction with the card game can be improved when the designability the action point cards 50 is high.

The design of the back faces of the game cards 2 is common to all game cards, and players are unable to identify the front face thereof from the back side.

Next, the play sheet 3 will be explained, referring FIG. 6. In the example shown in FIG. 6, a top part of the play sheet 3 is located on the opponent's side. As shown in FIG. 6, the play sheet 3 is formed in a rectangular shape, for example, a four-sided shape with all right angles. It is preferable for the play sheet 3 to be foldable in order to make it portable. Furthermore, it is preferable that the play sheet 3 is formed so as to be changed to the same size as the game card 2, since it can be carried together with the game cards.

Multiple areas (regions) are allocated on the play sheet 3, and each of areas represents a place where the player can place a game card(s) 2. In an explanation of the example, there are seven areas, that is, a draw pile area 30, an energy line 31, a front line 32, an action point area 33, a life area 34, a remove area 35, and an off-field area 36. These seven areas respectively have different functions, and the names of the areas may be any one as long as players can easily understand when playing.

As shown in FIG. 6, the energy line 31, the front line 32, and the action point area 33 are allocated so as to be of the same size and shape. The front line 32, where the character card(s) 20 for attacking the opponent is placed, is formed along the edge of the play sheet on the opponent's side. The action point area 33 is formed along the edge on the player's side. The energy line 31 is formed between the front line 32 and the action point area 33, so as to extend along the front line 32 and the action point area 33. The draw pile area 30 is an area where the player stacks his or her built deck face down.

The energy line (first placement area) 31 is an area where the character card(s) 20 and the field card(s) 30 are placed. The game card(s) placed on the energy line is the character card(s) 20 or the field cards 30 selected by the player from his or her hand. If there is no character card 20 on the energy line 31 or if the total energy is “0”, the player selects and places a character card(s) 20 or a field card(s) 30 with required energy information whose value is “0”.

The front line (second placement area) 32 is an area where the character card(s) 20 is placed. The player can use the character card(s) 20 placed in the front line to attack a character card(s) 20 in the front area 32 of the opponent player during a player's turn. During an opponent's turn, a character card(s) 20 placed in the front line 32 of the player is attacked by the character card(s) 20 placed in the opponent player's front area 32. The number of character cards 20 placed in the front line 32 is predetermined, and case where the number thereof is four, will be described below.

The action point area 33 is an area where an action point card(s) 50 is placed. The maximum number of the action point cards 50 that can be placed in the action point area 33 is predetermined. In description set forth below, an example, in which the maximum number is three, will be explained. When a player's turn begins, action point cards 50 are placed in an active state.

The life area 34 is an area where game cards 2 are placed. The game cards 2 in the life area 34 are initially placed face-down during a preparation phase of the game. When the attack value of character cards 20 placed in the front line 32 becomes 0 due to attacks from the opponent player, it becomes possible for the player to draw a game card(s) 2 placed in the life area 34. In addition, the number of game cards 2 that can be placed in the life area 34 is predetermined and, and an example, in which the number of game cards 2 is set to be seven, will be described.

The remove area 35 is an area where a new game card(s) can be temporarily moved and placed from the energy line 31 or the front line 32 when the player cannot place the new game card(s) on the energy line 31 or the front line 32 because the maximum number of game cards have been already placed on the energy line 31 or the front line 32 despite a player's desire to place the new game card there from his or her hand. The game cards in the remove area 35 are placed so as to be faced up.

The off-field area 36 is an area where character card(s) 20 removed from the game by attack of the opponent player, and event card(s) 40 which have been used, are placed. The game cards placed in the off-field area 36 cannot be used again until the game ends.

### <Game Preparation>

The player's play sheet 3 and the opponent's play sheet 3 are arranged face-to-face. The player selects game cards 2 with the same work title thereby forming a deck. The number of cards for the deck to be formed is predetermined. An example, in which 50 cards are used, will be described below. The player draws a specified number of game cards from the formed deck to form his or her hand. In this case, seven game cards 2 are drawn. The player places a predetermined number of game cards 2 face down in the life area. In this case, the number of game cards to be placed in the life area is seven. The player places three action point cards 50 in the action point area in a rest state.

### <Game Flow>

When a game begins, the players determine who goes first and who goes second in their match, and the players alternately take a turn starting with the first player, each player repeatedly takes a turn. Each turn is made up of multiple phases including a start phase, a move phase, a main phase, an attack phase, and an end phase, and the like. In the start phase, all game cards 2 located in the front line area 32, the energy line area 31, and the action point area 33 are activated. Next, the player draws one game card 2 from his or her deck.

In the move phase, it is possible to move character cards 20 placed in the energy line area to the front line area. When the maximum number of the game cards 2 which is four, have been already placed in the front line area, the player has an option to move any one of the character cards 20 to the remove area. After moving the character card(s) 20 to the remove area, the player can then move a character card(s) 20 placed in the energy line area to the front line area. Furthermore, it is also possible to replace character card(s) 20 placed in the energy line area with character card(s) 20 placed in the front line area.

In the main phase, the player can choose to perform at least one of the following actions:
Place a character card(s) 20 from his or her hand onto the front line 32 or the energy line 31,
Place a field card(s) 30 from his or her hand onto the energy line 31, and
Bring an event cards 40 to the play sheet 3.
   The character cards 20, the field cards 30, and the event cards 40 that can be played from your hand have a value of required energy information 121 which is less than or equal to the total value of occurrence energy information 120 of respective game cards 2 placed in the energy line 31, and have a value of the consumption action point information 122 which is less than or equal to that of active action point cards 50 placed in the action point area 33 in an active state. The character cards 20 and the field cards 30 which meet these requirements are placed in the rest state.

Further, in the main phase, it is possible to activate effects listed on the character card(s) 20 and the field card(s) 30 placed in the front line 32 and the energy line 31. When at least one of the character card 20, the field card 30, and the event card 40 is placed on the play sheet 3 from his or her hand, the action points allocated in the action point area 33 needs to be consumed.

In the attack phase, the player uses the character cards 20 placed on his or her front line to attack the defending character cards 20 placed on the opponent's front line. First, the player changes the character card 20 the player wants to use for the attack, from the active state to the rest state.

At this point, if the value specified in the power information of the attacking character card 20 is greater than the value specified in the power information of the opponent's character card 20 placed on the front line, the opponent's character card 20 placed on the front line is moved to the outside of the field. At this time, the information listed in the trigger information of the character card 20 to be moved out of the field is checked and the corresponding actions are executed.

If the attacking value specified in the power information of the attacking character card 20 is greater than the defense value specified in the power information of the opponent's character card 20 on the front line, the defending opponent may draw a character card 20 from his or her life area. If the drawn game card 2 successfully defends against the attack, the attacking character card 20 is defeated. If the player has another character card with which he or she wishes to attack, he or she changes a state of the attacking character card 20 from the active state to the rest state to initiate the attack.

If there are no more characters he or she wishes to attack or if the value specified in the power information of the attacking character card 20 is smaller than the value specified in the power information of the opponent's character card 20 on the front line, the attack phase comes to an end. Furthermore, the player has an option to pass the attack phase on his or her current turn to prepare for an attack on his or her next turn. In the end phase, the game cards 2 on the play sheet 3 in a rest state are changed to an active state thereby ending the turn.

### Embodiment 1

The Embodiment 1 will be explained below. In description set forth below, it is assumed that the game setup has already been completed, and each of the players hold seven game cards 2 as their hands. The seven game cards are placed face down in the life area of the play sheet 3, and three action point cards 50 are placed in a rest state in the action point area. FIG. 7 illustrates a state of a game toy 1 at a time point when the game setup is completed.

In the start phase, the player changes a state of the three action point cards 50 placed in the action point area 33 from a rest state to an active state. Subsequently, one game card 2 is drawn from the deck. At this point, as shown in FIG. 8, all the action point cards 50 in the action point area 33 become active.

In the move phase, the player moves as many character cards 20 placed in the energy line 31 as he or she likes to the front line 32. For example, in the first turn, if no character card 20 is placed in the energy line 31, the move phase transitions to the main phase.

In the main phase, the player can choose to perform at least one of the following actions:
Place character cards 20 from his or her hand onto the front line 32 or energy line 31,
Place a field card(s) 30 from his or her hand onto the energy line 31, and
Bring an event card(s) 40 onto the play sheet 3.
   In the first turn, since there are no game cards 2 in the energy line 31, the character cards 20, the field cards 30, or the event cards 40 which can be placed in the energy line 31 or the front line 32, are game cards 2 whose required energy information 121 indicates “0”, and consumption action point information 122 of these character cards 20, field cards 30, or event cards 40 is “3” or less. FIG. 9 illustrates an example in which a character card 20 whose required energy information 121 is “0” and whose consumption action point information 122 is “1”, is placed in the energy line 31.

Furthermore, if a player wishes to activate the effect of a character card 20 or a field card 30 placed in the energy line 31 during the main phase, the player changes the game cards from a rest state to an active state, thereby activating the content specified as the effect of the game card. In the example in FIG. 10, in case where the consumption action point information 122 of the character card 20 placed in the energy line 31 indicates “one card”, after one card among the action point cards 50 in the action point area 33 is changed to a rest state, the character card 20 is changed to an active state.

Next, in the attack phase, the player uses a character card 20 in the front line 32 to attack a character card 20 in the opponent's front line. In the example shown in FIG. 10, there are no character card 20 on the front line 32, so that the phase transitions to an end phase. In the end phase, as illustrated in FIG. 11, the player changes all the game cards on his or her play sheet to an active state thereby ending his or her turn.

### Example 2

Embodiment 2 will be explained below. In description set forth below, several turns have already been completed, and in the start phase, as shown in FIG. 12, there are two character cards 20 with required energy of “0”, occurrence energy of “2”, and consumption action points of “1” in the energy line 31, and there is a field card 30 with required energy of “2”, occurrence energy of “3”, and consumption action points of “1” in the player's hand.

In the move phase, the player moves one character card 20 placed in the energy line 31, to the front line area 32. FIG. 13 illustrates an example in which one character card 20 has been moved from the energy line 31 to the front line area 32.

In the example shown in FIG. 13, since the total value of occurrence energy information of the game cards placed in the energy line 31 is “2”, the player can place character cards 20 or field cards 30 with required energy information of “2” or less in the energy line 31. In other words, the player can place such a field card 30 with required energy of “2”, occurrence energy of “3”, and consumption action points of “1” in the energy line 31 from his or her hand.

In order to place this field card 30 in the energy line 31, one of the action point cards 50 in the action point area 33 must be changed from an active state to a rest state. FIG. 14 illustrates an example in which one action point card 50 in the action point area 33 has been changed from an active state to a rest state, and furthermore, a field card 30 with required energy of “2”, occurrence energy of “3”, and consumption action points of “1” has been placed from the player's hand into the energy line 31.

Next, in the attack phase, the player uses the character cards 20 placed in the front line 32 to attack the opponent's character cards 20 placed in the front line, and then the phase transitions to an end phase. In the end phase, as illustrated in FIG. 15, the player changes all the game cards on his or her play sheet to an active state thereby ending his or her turn.

The embodiments of the present invention have the effects set forth below.
(1) The character cards 20, the field cards 30, and the event cards 40 include the required energy information 121, which indicates conditions required to place them in the energy line 31 or the front line 32 on the play sheet 3, and the occurrence energy information 120, which serves as an element of the conditions for the required energy information 121 of other character cards 20, field cards 30, and event cards 40. By combining these conditions and elements, it becomes possible to create a thematic and immersive world, allowing a single game card to facilitate actions such as attacks and supports.
(2) The play sheet 3 consists of two distinct areas with different roles, that is, the energy line 31 and the front line 32, wherein in the energy line 31, game cards 2 serving as elements for the required energy information are placed, and in the front line 32, only game cards 2, which does not serve as elements for the required energy information and which is used for attack and defense, are placed. By this configuration, in order to introduce powerful game cards 2, the player must place more game cards 2 with occurrence energy information 120 indicating a higher value in the energy line 31. On the other hand, the game cards 2 placed in the energy line 31 cannot be used for attack or defense. Therefore, players can derive a new sense of enjoyment by strategizing and considering movements and placements of the game cards 2 to win the game.
(3) The play sheet 3 includes an action point area 33 in which action point cards 50 are placed. Action points of the action point cards 50 placed in the action point area 33 is counted based on a placement state (an active state or a rest state) thereof. By this configuration, there is no need for the action point cards 50 to contain information such as occurrence energy information 120, required energy information 121, or other game-related text information. Consequently, the action point cards 50 can be designed with high collectible value, thereby making them valuable as trading cards. Furthermore, since action point cards 50 are placed in the action point area 33, which is a dedicated placement area, it can appeal to the opposing player that the holder possesses rare and valuable cards.

As explained as the definition above, all game cards 2 have the same back face, but, the definition of the front face and that of back face may be replaced with each other.

Furthermore, in the above description, the example in which players respectively form a deck using game cards which 2 belong to the same work title for battles, but as long as character information 10, card information 11, energy information 12, and ability information 13, etc., is recorded on the game cards 2 based on common concepts, it is also possible to construct decks and play a battle with such game cards 2 belonging to different work title. Similarly, if character information 10, card information 11, energy information 12, and ability information 13, etc., is recorded on the game cards 2 based on common concepts, it is also possible to create decks by mixing game cards 2 from different work title for battles.

### Second Embodiment

Next, the second embodiment will be described below. The game device according to the first embodiment can be executed on a computer as a competitive game. FIG. 16 is a diagram showing an example of an overall configuration of the game system in this embodiment. As shown in FIG. 16, the game system is configured with player terminals 500 provided for players A and B, and a game server 600.

The player terminals 500 are computers capable of executing the game program, and they can be connected to a communication line N via wireless communication base stations and similar devices, allowing data communication with the game server 600. The player terminals 500 may be devices such as smartphones, mobile phones, handheld gaming devices, home gaming consoles, arcade gaming machines, personal computers, tablet computers, and controllers for home gaming consoles. Typically, there are two or more player terminals 500, each being operated by a different player.

The game server 600 is a server system consisting of one or more server devices and storage device(s) etc. The game server 600 is responsible for controlling the card game of the embodiments described above, providing various services for operating the card game, managing data required for the game operations, and delivering game programs and data required for running the game on player terminals 500.

FIG. 17 is a block diagram illustrating an example of the configuration of a player terminal 500. As shown in FIG. 17, the player terminal 500 comprises a communication unit 501, a storage unit 502, and a control unit 503.

The communication unit 501 is a processing unit that controls communication between the player terminal 500 and other devices such as the game server 600 and other player terminals 500, and is, for example, a communication interface, such as a network interface card. The storage unit 502 stores various data and the programs executed by the control unit 503, and may be a memory, a hard disk, or o the like.

The control unit 503 is a processing unit that oversees the entire player terminals 500, such as a processor. The control unit 503 includes a game card management unit 531, a play sheet display unit 532, a game information calculation unit 533, and a game execution unit 534. Each processing unit is an example of electronic circuits that a processor has or a process executed by the processor.

The game card management unit 531 manages the character cards 20, the field cards 30, the event cards 40, and the action point (AP) cards 50 as described above.

The play sheet display unit 532 displays the play sheets 3 of the player and the opponent on the player terminal 500.

The game information calculation unit 533 uses the occurrence energy information 120, the required energy information 121, and the consumption action point information 122 and the like, which are described above, in order to perform calculations required for the progression of the game.

The game execution unit 534 manages and executes the presentation and progression of the game. By such a terminal, it is possible to run the game without the need for physical game cards.

In accordance with this embodiments, the control of the card game described in the first embodiment is executed on the player terminal 500, and matching of match players etc. and the overall game management are performed on the game server 600, allowing for the execution of card games online, thereby increasing the player's interest. In the above-mentioned example, an example of a game performed via the game server 600 is explained, but it is also possible to run the game using only the player terminal 500.

Thus, the preferred embodiments of the present invention are described, but it should be understood that the present invention is not necessarily limited to the above embodiments and can be variously modified and implemented within the scope of its technical concept.

### EXPLANATION OF SYMBOLS

1 Game toy
2 Card game
3 Play sheet
31 Energy line
32 Front line
33 Action point area
120 Occurrence energy information
121 Required energy information
122 Consumption action points information
500 Player terminal
600 Game server

1. A game toy comprising:
first type game items, each of which is associated with a character; and
a play sheet on which the first type game items are placed,
wherein each of the first type game items includes first information, which indicates a first condition for placing one or more of the first type game items on the play sheet, and second information,
which is an element of the first condition of the first information of another first type game item, the play sheet includes a first placement area where some of the first type game items can be placed, and
the second information which is used to determine whether the first condition of the first information of the first type game item is met, is that of the first type game item placed in the first placement area.

2. The game toy according to claim 1, wherein the play sheet includes a second placement area which does not become a judgment target as to whether the condition of the first information of the first type game item is met, and on which a first type game item affecting a first type game item of an opposing player can be placed.

3. The game toy according to claim 2, further including second type game items, each of which is associated with a character, and serves as an element of the second condition for placing the first type game item on the play sheet, wherein the play sheet includes a third placement area where only some of the second type game items can be placed.

4. The game toy according to claim 3, wherein the first type game item includes third information that indicates the second condition for placing the first type game item on the play sheet, and
if the total of the elements of the second information of the first type game items placed in the second placement area satisfies the first condition of the first information of the first type game item, and if in a placement state of the second type game item placed in the third placement area, a placement change which satisfies the second condition of the third information of the first type game item is possible, the first type game item can be placed in either the first placement area or the second placement.

5. The game toy according to claim 4, wherein in the placement change of the second type game item, an orientation of the second type game item placed in the third placement area is changed from a first direction to a second direction.

6. The game toy according to claim 5, wherein the second type game item does not include information related to the game, which is the first information, the second information, and the third information.

7. The game toy according to claim 6, wherein each of the first type game items and each of the second type game items respectively include a character image.

8. The game toy according to claim 4, wherein when none of the first type game items is placed in the first placement area, the first type game items which do not include required elements for the first condition of the first information can be placed in either the first placement area or the second placement area.

9. The game toy according to claim 2, wherein the first type game item contains ability information affecting the first type game items of the opposing player when placed in the second placement area.

10. The game toy according to claim 1, wherein the play sheet is in a rectangle shape, and is foldable.

11. The game toy according to claim 3, wherein the second placement area is formed along a first end portion of the play sheet, and the third placement area is formed along a second end portion of the play sheet, and the first placement area is formed between the second placement area and the third placement area.

12. The game toy according to claim 11, wherein the first end portion is an end of an opposing player side in the game, and the second end portion is an end of a player side in the game.

13. The game toy according to claim 11, wherein the first placement area, the second placement area, and the third placement area are formed so as to be in the same size as one another on the play sheet.

14. The game toy according to claim 11, wherein the second placement area is formed adjacent to the first placement area and the third placement area.

15. The game toy according to claim 4, further including a third type game item which can only be placed in the first placement area, wherein the third type game item includes the first information, the second information, and the third information.

16. The game toy according to claim 15, wherein for each of two or more works, the first type game items, the second type game items, and the third type game items are prepared, and in a single match, the first type game items, the second type game items, and the third type game items of the two or more works can be used in a mixed manner.

17. The game toy according to claim 15, wherein for each of two or more works, the first type game items, the second type game items, and the third type game items are prepared, and in a single match, the first type game items, the second type game items, and the third type game items of the two or more works cannot be used in a mixed manner.

18. A computer program which causes a computer to function as a display unit for displaying a play sheet on which first type game items, each of which is associated with a character are placed, and as a control unit for controlling a game,
wherein the first type game items respectively include first information indicating a first condition for placing the first type game item on the play sheet, and second information, which serves as an element of the first condition of the first information of another first type game item, and
the play sheet includes a first placement area in which some of the first type game items can be placed,
the control unit uses the second information of the first type game item placed in the first placement area, and determines whether or not the first condition of the first information of the first type game item is met.
